(19) United States
(12) Patent Application Publication
(10) Pub. No.: US 2012/0288223 A1
(43) Pub. Date: Nov. 15, 2012

(54) Hydrodynamic bearing assembly and motor having the same

(75) Inventor: Chang Jo Yu, Suwon (KR)

(73) Assignee: SAMSUNG ELECTRO-MECHANICS CO., LTD., Suwon (KR)

(21) Appl. No.: 13/137,220

(22) Filed: Jul. 28, 2011

(30) Foreign Application Priority Data
May 9, 2011 (KR) 10-2011-0043356

(51) Int. Cl. F16C 32/06

(52) U.S. Cl. 384/112; 384/115

(57) ABSTRACT

There are provided a hydrodynamic bearing assembly and a motor having the same, the hydrodynamic bearing assembly including a shaft rotating together with a rotor case; and a sleeve rotatably supporting the shaft, wherein at least one of the shaft and the sleeve has first and second dynamic pressure grooves formed therein, the first dynamic pressure groove being disposed in an upper portion of at least one of the shaft and the sleeve in an axial direction and having a herringbone shape and the second dynamic pressure groove being disposed in a lower portion of at least one of the shaft and the sleeve in the axial direction so as to be spaced apart from the first dynamic pressure groove and having a spiral shape.

### CROSS-REFERENCE TO RELATED APPLICATIONS

This application claims the priority of Korean Patent Application No. 10-2011-0043356 filed on May 9, 2011, in the Korean Intellectual Property Office, the disclosure of which is incorporated herein by reference.

### BACKGROUND OF THE INVENTION

1. Field of the Invention

The present invention relates to a hydrodynamic bearing assembly and a motor having the same, and more particularly, to a hydrodynamic bearing assembly having a lubricating fluid filled therein, and a motor having the same.

2. Description of the Related Art

A small spindle motor used in a hard disk drive (HDD) is generally provided with a hydrodynamic bearing assembly, and a bearing clearance formed between a shaft and a sleeve of the hydrodynamic bearing assembly is filled with a lubricating fluid such as oil. The oil filling the bearing clearance generates fluid dynamic pressure while being pumped, thereby rotatably supporting the shaft.

That is, the hydrodynamic bearing assembly generally generates dynamic pressure through a dynamic pressure groove to thereby promote stability in the rotational driving of a motor.

Meanwhile, in accordance with the recent trend toward the thinning of a hard disk drive, the thinning and miniaturization of a spindle motor have also been demanded. However, in the case of reducing an interval between dynamic pressure grooves, that is, a span length, in accordance with the demand of the thinning and the miniaturization of the spindle motor, sufficient rotational force may not be obtained.

In addition, sufficient rotational force is not obtained, such that rotational characteristics are deteriorated or the stability of a rotor is deteriorated due to external force, whereby an improvement in recording density, which is an ultimate object of the thinning of the hard disk drive, may not be realized.

Therefore, the development of technology capable of implementing the thinning of the spindle motor simultaneously with increasing the span length has been required.

### SUMMARY OF THE INVENTION

An aspect of the present invention provides a hydrodynamic bearing assembly having improved rotational characteristics, and a motor having the same.

According to an aspect of the present invention, there is provided a hydrodynamic bearing assembly including: a shaft rotating together with a rotor case; and a sleeve rotatably supporting the shaft, wherein at least one of the shaft and the sleeve has first and second dynamic pressure grooves formed therein, the first dynamic pressure groove being disposed in an upper portion of at least one of the shaft and the sleeve in an axial direction and having a herringbone shape and the second dynamic pressure groove being disposed in a lower portion of at least one of the shaft and the sleeve in the axial direction so as to be spaced apart from the first dynamic pressure groove and having a spiral shape.

The hydrodynamic bearing assembly may further include a thrust plate fixedly mounted on one end of the shaft and rotating together with the shaft, wherein the sleeve disposed to face to an upper surface of the thrust plate includes an in-pumping groove formed therein, the in-pumping groove generating dynamic pressure inwardly in a radial direction.

The in-pumping groove may have a spiral shape or a herringbone shape.

A distal end of the second dynamic pressure groove may be disposed to be spaced apart from an upper surface of the thrust plate in order to effectively convert dynamic pressure generated by cooperation of the second dynamic pressure groove and an in-pumping groove into supporting force in a radial direction.

The thrust plate may have a flat bottom surface in order to prevent dynamic pressure from being generated.

The sleeve may include a depressed oil storing part so as to be disposed between the first and second dynamic pressure grooves.

The hydrodynamic bearing assembly may further include a cover plate fixedly mounted on a mounting part formed in a lower portion of the sleeve to thereby prevent a lubricating fluid from being leaked.

The cover plate may have a flat upper surface in order to prevent dynamic pressure from being generated.

According to another aspect of the present invention, there is provided a spindle motor including: a base member having a sleeve housing extended upwardly in an axial direction; a sleeve fixedly mounted on the, sleeve housing; a shaft rotatably mounted in the sleeve; a thrust plate mounted in a lower portion of the shaft to thereby rotate together with the shaft; and a cover plate mounted on the sleeve so as to be disposed under the thrust plate to thereby prevent a lubricating fluid from being leaked, wherein at least one of the shaft and the sleeve has first and second dynamic pressure grooves formed therein, the first dynamic pressure groove being disposed in an upper portion of at least one of the shaft and the sleeve in an axial direction and having a herringbone shape and the second dynamic pressure groove being disposed in a lower portion of at least one of the shaft and the sleeve in the axial direction so as to be spaced apart from the first dynamic pressure groove and having a spiral shape.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view schematically showing a spindle motor according to an embodiment of the present invention;

FIG. 2 is an enlarged view of part X of FIG. 1;

FIG. 3 is a view showing first and second dynamic pressure grooves according to an embodiment of the present invention;

FIG. 4 is a view describing an operation of a hydrodynamic bearing assembly according to an embodiment of the present invention;

FIG. 5 is a comparitive graph describing an operation of a hydrodynamic bearing assembly according to an embodiment of the present invention;

FIG. 6 is a cross-sectional view schematically showing a hydrodynamic bearing assembly according to another embodiment of the present invention corresponding to part X of FIG. 1; and

FIG. 7 is a view showing first and second dynamic pressure grooves according to another embodiment of the present invention.

### DETAILED DESCRIPTION OF THE PREFERRED EMBODIMENT

Embodiments of the present invention will now be described in detail with reference to the accompanying drawings. However, it should be noted that the spirit of the present invention is not limited to the embodiments set forth herein and those skilled in the art and understanding the present invention could easily accomplish retrogressive inventions or other embodiments included in the spirit of the present invention by the addition, modification, and removal of components within the same spirit, but those are to be construed as being included in the spirit of the present invention.

Further, when it is determined that a detailed description of the known art related to the present invention may obscure the gist of the present invention, the detailed description thereof will be omitted.

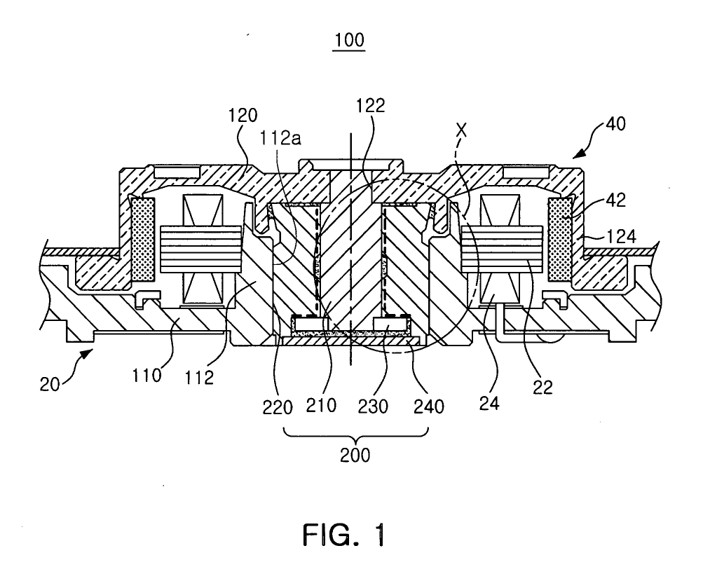

FIG. 1 is a cross-sectional view schematically showing a spindle motor according to an embodiment of the present invention.

Referring to FIG. 1, a spindle motor 100 according to an embodiment of the present invention may include a base member 110, a rotor case 120, and a hydrodynamic bearing assembly 200.

In addition, the above-mentioned hydrodynamic bearing assembly 200 may include a shaft 210, a sleeve 220, a thrust plate 230, and a cover plate 240.

Meanwhile, the spindle motor 100, which is, for example, a motor used in a hard disk drive rotating a hard disk, may be mainly configured of a stator 20 and a rotor 40.

The stator 20, which refers to all fixed members, with the exception of rotating members, may include the base member 110, the sleeve 220, the cover plate 240, a stator core 22, and the like.

In addition, the rotor 40, which refers to members rotating about the shaft 210, may include a rotor case 120, a magnet 42, the thrust plate 230, and the like.

A rotational driving scheme of the above-mentioned rotor 40 will be simply described. The rotor case 120 may include a coupling hole 122 having the shaft 120 press-fitted thereinto and coupled thereto and a magnet coupling part 124 having an annular ring shaped magnet 42 disposed in an inner surface thereof.

In addition, the magnet 42 may be made of a permanent magnet generating magnetic force having a predetermined strength by alternately magnetizing an N pole and an S pole thereof in a peripheral direction.

Further, the stator core 22 of the stator 20 has a coil 24 wound therearound.

Meanwhile, the magnet 42 provided on an inner surface of the magnet coupling part 124 is disposed to face the stator core 22 having the coil 24 wound therearound, and the rotator case 120 rotates due to electromagnetic interaction between the magnet 42 and the coil 24.

At this time, the rotor case 120 rotates together with the shaft 210 based on the shaft 210, such that the rotor 40 including the rotor case 120 rotates.

Here, terms regarding directions will be defined. In FIG. 1, an axial direction refers to a vertical direction based on the shaft 210, a radial direction refers to a direction toward an outside edge of the rotor case 120 based on the shaft 210 or a direction toward the center of the shaft 210 based on the outside edge of the rotor case 120, and a peripheral direction refers to a direction rotating around an outer peripheral surface of the shaft 210.

The base member 110 may have a sleeve housing 112 extended upwardly in the axial direction. The sleeve housing 112 may have, for example, a cylindrical shape and may have a mounting hole 112a formed therein such that the sleeve 220 may be inserted thereinto.

Meanwhile, the stator core 22 is mounted on an outer peripheral surface of the sleeve housing 112, such that a distal edge thereof is disposed to face the magnet 42.

The rotor case 120 may be coupled to an upper end portion of the shaft 210 and be fixedly coupled thereto by an adhesive. That is, the rotor case 120 may be fixedly coupled to the shaft 210 by the adhesive such that it may rotate together with the shaft 210.

Meanwhile, as described above, the rotor case 120 may include the Coupling hole 122 formed in a central portion thereof and the magnet coupling part 124 extended downwardly in the axial direction from an edge thereof, the coupling hole 122 having the shaft 210 penetrating therethough and coupled thereto.

In other words, the rotor case 120 may have a cup shape in which a hole is formed in a central portion thereof.

Meanwhile, the hydrodynamic bearing assembly 200 has a bearing clearance formed therein, and the lubricating fluid filling the bearing clearance generates fluid dynamic pressure while being compressed at the time of the rotation of the shaft 210, to thereby serve to rotatably support the shaft 210.

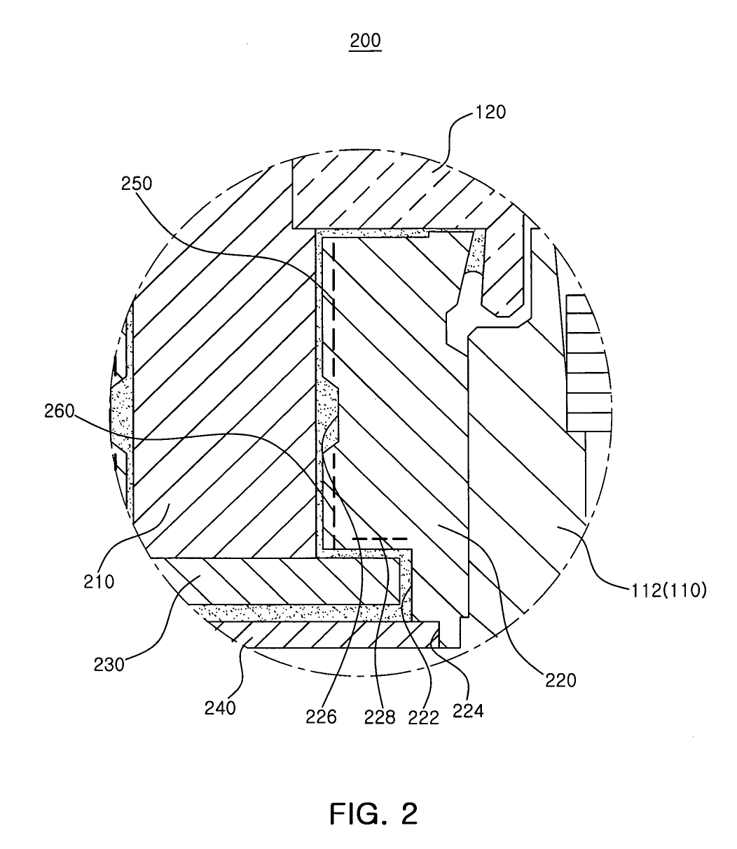

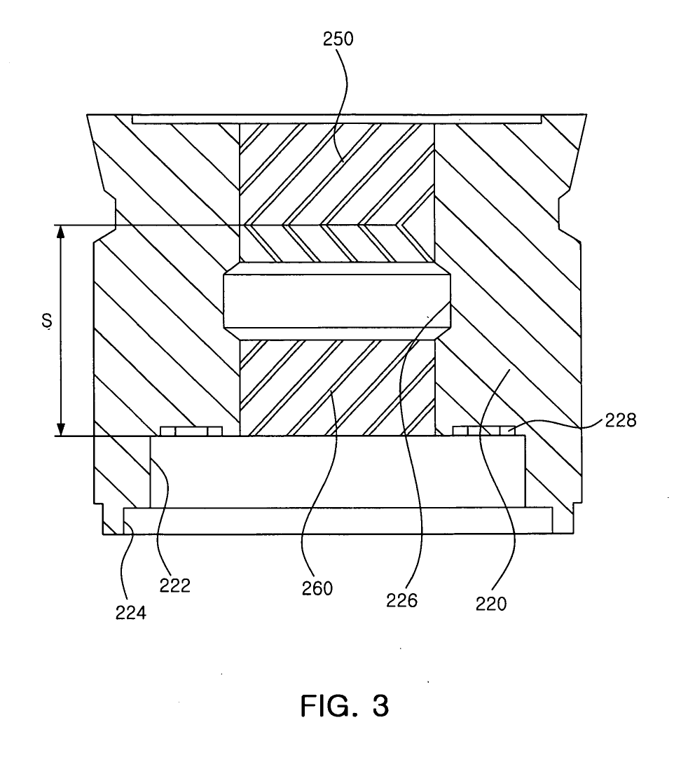

Hereinafter, the shaft 210, the sleeve 220, the thrust plate 230, and the cover plate 240 configuring the hydrodynamic bearing assembly 200 will be described in detail with reference to FIGS. 2 and 3.

FIG. 2 is an enlarged view of part X of FIG. 1; and FIG. 3 is a view showing first and second dynamic pressure grooves according to an embodiment of the present invention.

The shaft 210 is rotatably mounted in the sleeve 220, such that it rotates together with the rotor case 120 at the time of the rotation of the rotor case 120. That is, when the rotor case 120 rotates by electromagnetic interaction between the magnet 42 (See FIG. 1) and the coil 24 (See FIG. 1), the shaft 210 rotates together with the rotor case 120.

Meanwhile, in the case in which the shaft 210 is coupled to the sleeve 220, an outer peripheral surface of the shaft 210 may be disposed to be spaced apart from an inner peripheral surface of the sleeve 220 by a predetermined interval, such that a bearing clearance is formed. The bearing clearance is filled with a lubricating fluid.

The sleeve 220 is disposed under the rotor case 120 and rotatably supports the shaft 210. Meanwhile, the sleeve 220 may be fixedly mounted on the sleeve housing 112 of the base member 110. That is, an outer peripheral surface of the sleeve 220 may be mounted on an inner peripheral surface of the sleeve housing 112, in such a manner as to be fixed thereto by an adhesive, or the like.

In addition, the sleeve 220 may have an insertion groove 222 formed in a lower portion thereof, the insertion groove 222 having the thrust plate 230 inserted thereinto. In a lower portion of the insertion groove 222, a mounting part 224 having the cover plate 240 fixedly coupled thereto such that the lubricating fluid does not flow downwardly, may be provided.

In other words, the sleeve 220 may include the mounting part 224 formed on a lower portion thereof, the mounting part 224 having the cover plate 240 fixedly mounted thereto. In addition, the sleeve 220 may include the insertion groove 222 depressed upwardly in the axial direction from the mounting part 224 and having a diameter smaller than that of the mounting part 224.

Meanwhile, the hydrodynamic bearing assembly 200 according to an embodiment of the present invention may include first and second dynamic pressure grooves 250 and 260 formed in at least one of the shaft 210 and the sleeve 220 thereof.

In addition, the first dynamic pressure groove 250 may have a herringbone shape and the second dynamic pressure groove 260 may be disposed to be spaced apart from the first dynamic pressure groove 250 and have a spiral shape.

In other words, the first dynamic pressure groove 250 may be disposed in an upper portion of the shaft 210 and the sleeve 220 and the second dynamic pressure groove 260 may be disposed under the first dynamic pressure groove 260.

In addition, the first dynamic pressure groove 250 has the herringbone shape and the second dynamic pressure groove 260 has the spiral shape, whereby a span length (S) may be increased. Here, the span length (S) indicates a distance between an area at which the maximum dynamic pressure is generated while the lubricating fluid is compressed by the first dynamic pressure groove 250 and an area at which the maximum dynamic pressure is generated while the lubricating fluid is compressed by the second dynamic pressure groove 260.

The span length (S) may be increased as shown in FIG. 3 in the case in which the first dynamic pressure groove 250 has the herringbone shape and the second dynamic pressure groove 260 has the spiral shape, as compared to the case in which both of the first and second dynamic pressure grooves 250 and 260 have the herringbone shape.

Therefore, rotational characteristics of the shaft 210 may be improved. That is, the shaft 210 may be supported through by the dynamic pressure generated while the lubricating fluid is compressed by the first and second dynamic pressure grooves 250 and 260. As a distance between two supported portions of the shaft 210 is increased, the shaft 210 may more stably rotate without shaking.

Therefore, in the case in which the first dynamic pressure groove 250 has the herringbone shape and the second dynamic pressure groove 260 has the spiral shape as described in the embodiment of the present invention, the span length (S) is increased, such that the shaft 210 may more stably rotate.

Meanwhile, the sleeve 220 does not include a circulation hole formed therein, the circulation hole having the lubricating fluid circulated therethrough. Therefore, the dynamic pressure generated by the second dynamic pressure groove 260 may be increased without being dispersed.

As a result, the dynamic pressure generated by the second dynamic pressure groove 260 is increased, such that the shaft 210 may be more stably supported at the time of the rotation thereof and have improved rotational characteristics.

In addition, the sleeve 220 may include a depressed oil storing part 226 so as to be disposed between the first and second dynamic pressure grooves 250 and 260. The oil storing part 226 serves to supply the lubricating fluid downwardly of the shaft 210 at the time of the rotation of the shaft 210.

The thrust plate 230 is fixedly mounted on one end of the shaft 210 to thereby rotate together with the shaft 210. In other words, the thrust plate 230 is fixedly mounted on a lower portion of the shaft 210 and is inserted into the insertion groove 222 of the sleeve 220.

In addition, the insertion groove 222 of the sleeve 220, disposed to face an upper surface of the thrust plate 230, has an in-pumping groove 228 formed in a ceiling surface thereof, the in-pumping groove 228 generating dynamic pressure inwardly in a radial direction at the time of the rotation of the thrust plate 230.

Here, the bearing clearance formed in the hydrodynamic bearing assembly 200 will be described. As described above, when the shaft 210 and the sleeve 220 are coupled to each other, the outer peripheral surface of the shaft 210 and the inner peripheral surface of the sleeve 220 are disposed to be spaced apart from each other by a predetermined interval to thereby form the bearing clearance.

This bearing clearance is connected to a bearing clearance formed by the upper surface of the thrust plate 230 and the ceiling surface of the insertion groove 222 of the sleeve 220.

In addition, a bearing clearance is also formed by the thrust plate 230 and the cover plate 240. This bearing clearance is connected to the above-mentioned bearing clearance formed by the upper surface of the thrust plate 230 and the ceiling surface of the insertion groove 222 of the sleeve 220.

Meanwhile, the bearing clearances are filled with the lubricating fluid. When the shaft 210 rotates, the lubricating fluid moves, such that it flows in the bearing clearance formed by the thrust plate 230 and the cover plate 240.

However, when the lubricating fluid continuously flows in the bearing clearance formed by the thrust plate 230 and the cover plate 240, the shaft 210 may excessively float upwardly.

In order to prevent the shaft 210 from excessively floating upwardly, the insertion groove 222 of the sleeve 220 disposed to face the upper surface of the thrust plate 230 has the in-pumping groove 228 formed in a ceiling surface thereof, the in-pumping groove 228 generating dynamic pressure inwardly in the radial direction at the time of the rotation of the thrust plate 230. That is, in order to constantly maintain pressure of the bearing clearance formed by the thrust plate 230 and the cover plate 240, which may be increased due to the movement of the lubricating fluid, the in-pumping groove 228 generating dynamic pressure inwardly in the radial direction may be formed in the ceiling surface of the insertion groove 222.

In addition, the in-pumping groove 228 may have a spiral shape or a herringbone shape. However, a shape of the in-pumping groove is not limited thereto but may be any shape as long as dynamic pressure may be generated inwardly in the radial direction at the time of the rotation of the shaft 210.

Although the embodiment describes the case in which the in-pumping groove 228 is formed in the ceiling surface of the insertion groove 222 by way of example, the present invention is not limited thereto. The in-pumping groove 228 may also be formed in the upper surface of the thrust plate 230.

Meanwhile, the thrust plate 230 may have a flat bottom surface in order to prevent dynamic pressure from being generated. That is, a groove for generating dynamic pressure may not be formed in the bottom of the thrust plate 230.

Therefore, an excessive increase in the fluid dynamic pressure in the bearing clearance formed by the thrust plate 230 and the cover plate 240 due to the rotation of the thrust plate 230 may be prevented.

The cover plate 240 is fixedly mounted on the mounting part 224 formed on the lower portion of the sleeve 220 to thereby serve to prevent leakage of the lubricating fluid. Meanwhile, the cover plate 240 may be fixedly mounted on the mounting part 224 by an adhesive or by performing welding.

In addition, the cover plate 240 and the thrust plate 230 include the bearing clearance formed therebetween and the cover plate 240 prevents the lubricating fluid filling the bearing clearance from being leaked to the outside.

The cover plate 240 may have a flat upper surface in order to prevent dynamic pressure from being generated. That is, a groove for generating dynamic pressure may also not be formed in the upper surface of the cover plate 240.

Therefore, an excessive increase in fluid dynamic pressure in the bearing clearance formed by the thrust plate 230 and the cover plate 240 due to the rotation of the thrust plate 230 may be prevented.

As described above, the span length (S) maybe increased by the first dynamic pressure groove 250 having the herringbone shape and the second dynamic pressure groove 260 disposed to be spaced apart from the first dynamic pressure groove 250 and having the spiral shape, whereby the rotational characteristics of the shaft 210 may be improved.

In addition, the excessive floating of the shaft 210 may be prevented by the in-pumping groove 228 formed in the ceiling surface of the insertion groove 222 of the sleeve 220. That is, an excessive increase in the pressure in the bearing clearance formed by the thrust plate 230 and the cover plate 240 may be prevented by the in-pumping groove 228, whereby excessive floating of the shaft 210 may be prevented.

In addition, the sleeve 220 according to the embodiment of the present invention does not include a circulation hole for circulating the lubricating fluid therethrough, whereby the dispersion of the dynamic pressure generated by the second dynamic pressure groove 260 through the circulation hole may be prevented.

Therefore, pressure applied downwardly of the shaft 210 is increased, such that even though the shaft 210 is inclined, the shaft 210 may easily return to a central position thereof . As a result, the rotational characteristics of the shaft 210 may be improved.

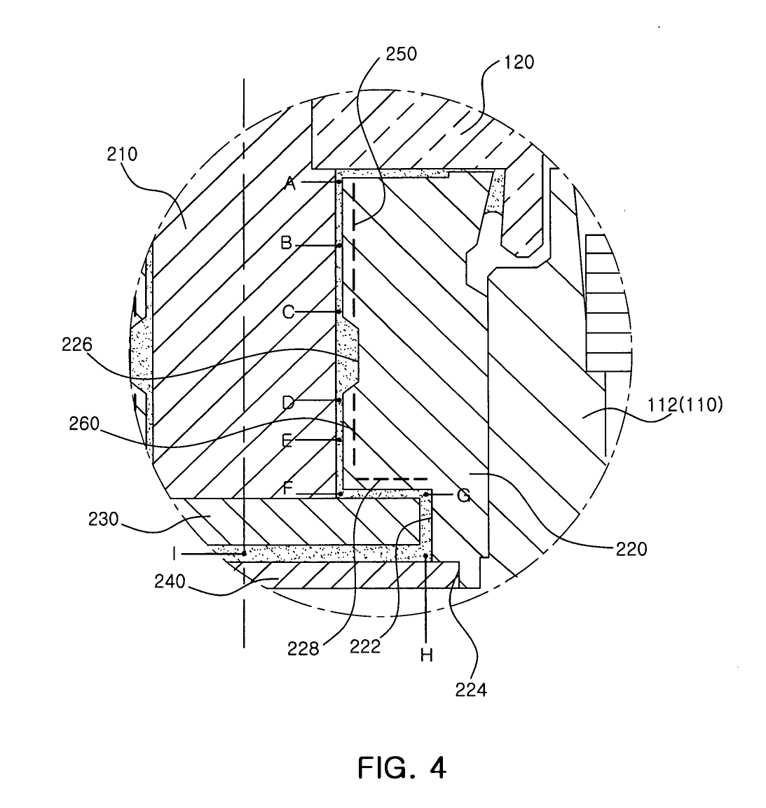

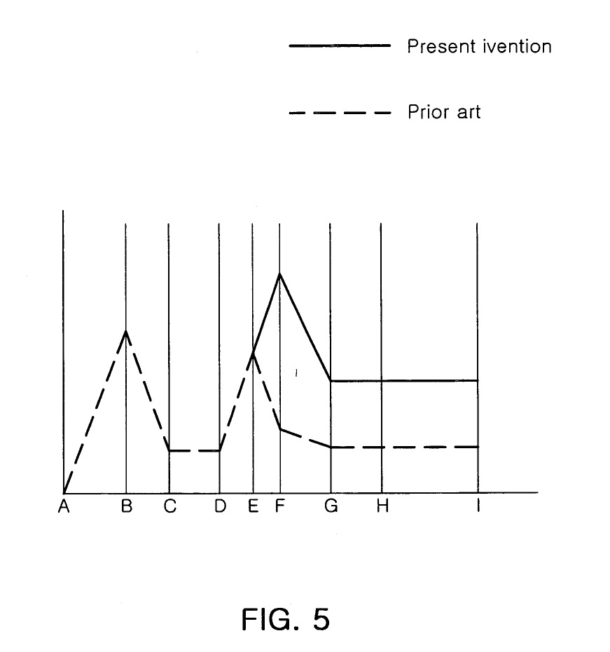

Hereinafter, an operation of a hydrodynamic bearing assembly according to an embodiment of the present invention will be described with reference to FIGS. 4 and 5.

FIG. 4 is a view describing an operation of a hydrodynamic bearing assembly according to an embodiment of the present invention. FIG. 5 is a comparitive graph describing an operation of a hydrodynamic bearing assembly according to an embodiment of the present invention.

Referring to FIG. 4, the bearing clearance formed by the ceiling surface of the insertion groove 222 of the sleeve 220 and the upper surface of the thrust plate 230, as well as the bearing clearance formed by the shaft 210 and sleeve 220, may be filled with the lubricating fluid.

In addition, the bearing clearance formed by the thrust plate 230 and the cover plate 240 may also be filled with the lubricating fluid. As a result, the lubricating fluid fills upper portions of the shaft 210 and the sleeve 220 to an upper portion of the cover plate 240. This liquid filled structure is called a lubricating fluid full-fill structure.

Meanwhile, as shown in FIG. 4, the respective portions from an upper portion area to a lower portion area of the bearing clearance formed by the shaft 210 and the sleeve 220 may be sequentially called A, B, C, D, E, and F, portions of the bearing clearance formed by the outer peripheral surface of the thrust plate 230 and the insertion groove 222 of the sleeve 220 are called G and H, and a portion of the bearing clearance formed by the thrust plate 230 and the cover plate 240 is called I.

Referring to FIG. 5, the case in which both of the first and second dynamic pressure grooves 250 and 260 have the herringbone shape is shown as graph I. In addition, the case in which the first dynamic pressure groove 250 has the herringbone shape and the second dynamic pressure groove 260 has the spiral shape as described in the embodiment of the present invention is shown as graph II.

When graph I is compared with graph II, the hydrodynamic bearing assembly 200 according to the embodiment of the present invention has a higher fluid dynamic pressure, particularly in areas E and F, as compared to the case in which both of the first and second dynamic pressure grooves 250 and 260 have the herringbone shape.

As described above, the dynamic pressure generated by the second dynamic pressure groove 260 having the spiral shape is increased, whereby an axial length of the second dynamic pressure groove 260 having the spiral shape may be reduced. Therefore, as described above, the span length (S) corresponding to the interval between the first and second dynamic pressure grooves 250 and 260 may be increased, whereby the rotational characteristics of the shaft 210 may be improved.

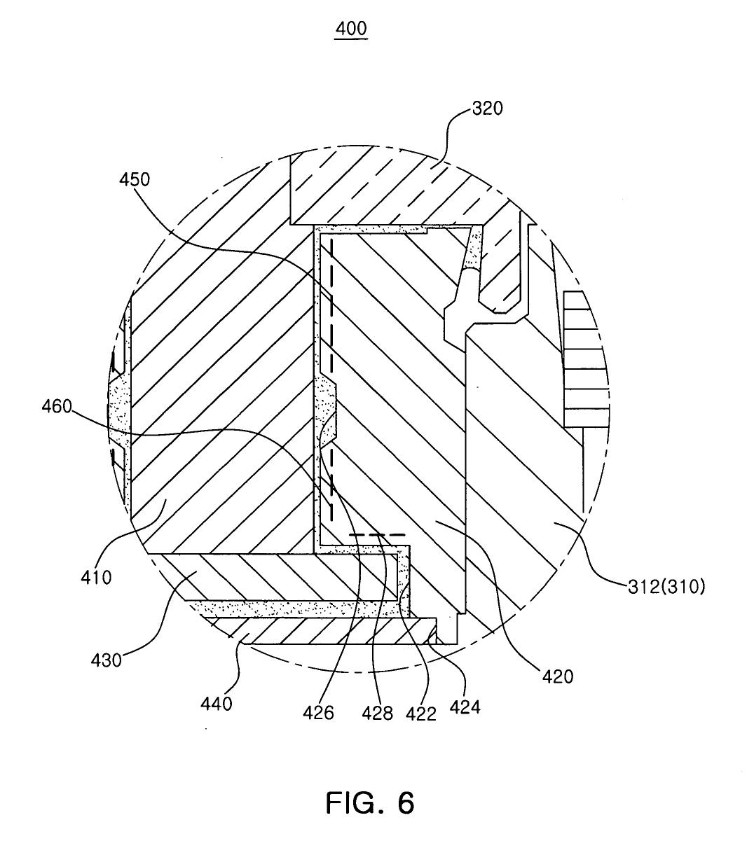

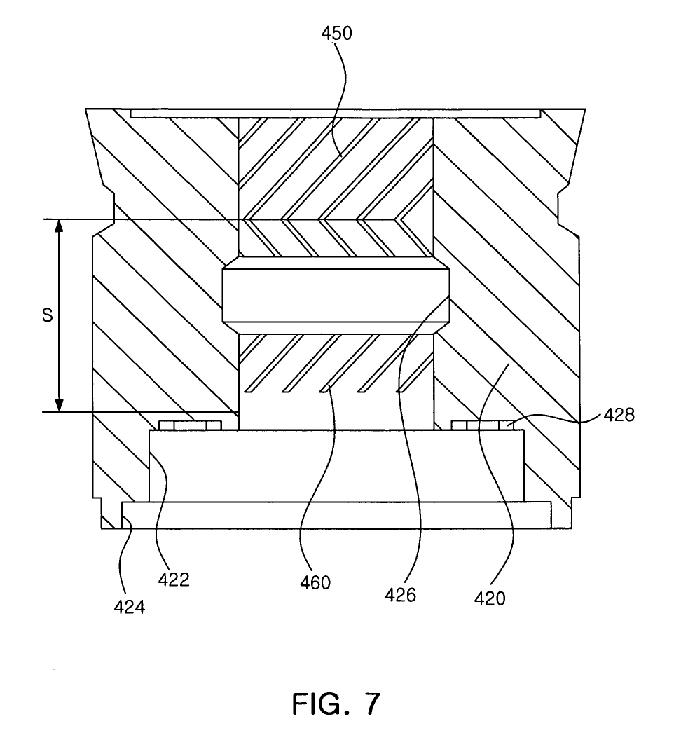

Hereinafter, a hydrodynamic bearing assembly according to another embodiment of the present invention will be described with reference to FIGS. 6 and 7.

However, a detailed description of the same components as the components of the hydrodynamic bearing assembly 200 according to the embodiment of the present invention as described above will be substituted with the above-mentioned description and will thus be omitted.

FIG. 6 is a cross-sectional view schematically showing a hydrodynamic bearing assembly according to another embodiment of the present invention corresponding to part X of FIG. 1; and FIG. 7 is a view showing first and second dynamic pressure grooves according to another embodiment of the present invention.

Referring to FIGS. 6 and 7, a hydrodynamic bearing assembly 400 according to another embodiment of the present invention may include a shaft 410, a sleeve 420, a thrust plate 430, and a cover plate 440.

Meanwhile, other components with the exception of a second dynamic pressure groove 460 are the same as those of the above-mentioned hydrodynamic bearing assembly 200. Therefore, a detailed description thereof will be omitted.

Meanwhile, the hydrodynamic bearing assembly 400 according to another embodiment of the present invention may also include first and second dynamic pressure grooves 450 and 460 formed in at least one of the shaft 410 and the sleeve 420 thereof.

In addition, the first dynamic pressure groove 450 may have a herringbone shape and the second dynamic pressure groove 460 may be disposed to be spaced apart from the first dynamic pressure groove 450 and have a spiral shape.

In other words, the first dynamic pressure groove 450 may be disposed in an upper portion of the shaft 410 and the sleeve 420 and the second dynamic pressure groove 460 may be disposed under the first dynamic pressure groove 450.

However, a distal end of the second dynamic pressure groove 460 of the hydrodynamic bearing assembly 400 according to another embodiment of the present invention may be disposed to be spaced apart from an upper surface of the thrust plate 430 in order to effectively convert dynamic pressure generated by cooperation of the second dynamic pressure groove 460 and an in-pumping groove 432 into supporting force in a radial direction.

That is, interference between dynamic pressure generated by the in-pumping groove 432 and dynamic pressure generated by the second dynamic pressure groove 460 may be reduced in the case in which the distal end of the second dynamic pressure groove 460 is disposed to be spaced apart from the upper surface of the thrust plate 430, as compared to the case in which the distal end of the second dynamic pressure groove 460 is extended to a distal end of the shaft 410 so as to be adjacent to the upper surface of the thrust plate 430.

Therefore, pressure in a bearing clearance formed by the thrust plate 430 and the cover plate 440 may be more easily controlled.

As set forth above, according to the embodiments of the present invention, the second dynamic pressure groove formed under the first dynamic pressure groove has the spiral shape, such that the span length may be increased, whereby the rotational characteristics of the shaft may be improved.

While the present invention has been shown and described in connection with the embodiments, it will be apparent to those skilled in the art that modifications and variations can be made without departing from the spirit and scope of the invention as defined by the appended claims.

What is claimed is:

1. A hydrodynamic bearing assembly comprising:
a shaft rotating together with a rotor case; and
a sleeve rotatably supporting the shaft,
wherein at least one of the shaft and the sleeve has first and second dynamic pressure grooves formed therein, the first dynamic pressure groove being disposed in an upper portion of at least one of the shaft and the sleeve in an axial direction and having a herringbone shape and the second dynamic pressure groove being disposed in a lower portion of at least one of the shaft and the sleeve in the axial direction so as to be spaced apart from the first dynamic pressure groove and having a spiral shape.

2. The hydrodynamic bearing assembly of claim 1, further comprising a thrust plate fixedly mounted on one end of the shaft and rotating together with the shaft,
wherein the sleeve disposed to face to an upper surface of the thrust plate includes an in-pumping groove formed therein, the in-pumping groove generating dynamic pressure inwardly in a radial direction.

3. The hydrodynamic bearing assembly of claim 2, wherein the in-pumping groove has a spiral shape or a herringbone shape.

4. The hydrodynamic bearing assembly of claim 1, wherein a distal end of the second dynamic pressure groove is disposed to be spaced apart from an upper surface of the thrust plate in order to effectively convert dynamic pressure generated by cooperation of the second dynamic pressure groove and an in-pumping groove into supporting force in a radial direction.

5. The hydrodynamic bearing assembly of claim 3, wherein the thrust plate has a flat bottom surface in order to prevent dynamic pressure from being generated.

6. The hydrodynamic bearing assembly of claim 1, wherein the sleeve includes a depressed oil storing part so as to be disposed between the first and second dynamic pressure grooves.

7. The hydrodynamic bearing assembly of claim 1, further comprising a cover plate fixedly mounted on a mounting part formed in a lower portion of the sleeve to thereby prevent a lubricating fluid from being leaked.

8. The hydrodynamic bearing assembly of claim 7, wherein the cover plate has a flat upper surface in order to prevent dynamic pressure from being generated.

9. A spindle motor comprising:
a base member having a sleeve housing extended upwardly in an axial direction;
a sleeve fixedly mounted on the sleeve housing;
a shaft rotatably mounted in the sleeve;
a thrust plate mounted in a lower portion of the shaft to thereby rotate together with the shaft; and
a cover plate mounted on the sleeve so as to be disposed under the thrust plate to thereby prevent a lubricating fluid from being leaked,
wherein at least one of the shaft and the sleeve has first and second dynamic pressure grooves formed therein, the first dynamic pressure groove being disposed in an upper portion of at least one of the shaft and the sleeve in an axial direction and having a herringbone shape and the second dynamic pressure groove being disposed in a lower portion of at least one of the shaft and the sleeve in the axial direction so as to be spaced apart from the first dynamic pressure groove and having a spiral shape.
